(19) United States
(12) Patent Application Publication
(10) Pub. No.: US 2014/0045009 A1
(43) Pub. Date: Feb. 13, 2014

(54) SECONDARY BATTERY

(71) Applicant: SAMSUNG SDI CO., LTD., Yongin-si (KR)

(72) Inventor: Daekyu KIM, Yongin-si (KR)

(73) Assignee: SAMSUNG SDI CO., LTD., Yongin-si (KR)

(21) Appl. No.: 13/751,756

(22) Filed: Jan. 28, 2013

(30) Foreign Application Priority Data
Aug. 8, 2012 (KR) 10-2012-0086924

(51) Int. Cl. H01M 2/12

(52) U.S. Cl. CPC H01M 2/1241
USPC 429/89

(57) ABSTRACT

A secondary battery includes an electrode assembly, a can accommodating the electrode assembly, and a cap assembly sealing a top portion of the can and having a cap-up. The cap-up includes a base plate, a terminal in a protruding relationship with respect to an upper portion of the base plate, the terminal being at a center of the cap-up, a connection part connecting the base plate and the terminal, and a trench-shaped safety vent in the base plate.

### CROSS-REFERENCE TO RELATED APPLICATION

This application claims priority under 35 U.S.C. §119 to Korean Patent Application No. 10-2012-0086924, filed on Aug. 8, 2012, in the Korean Intellectual Property Office, and entitled: “Secondary Battery,” the entire contents of which are incorporated herein by reference.

### BACKGROUND

1. Field

Embodiments relate to a secondary battery.

2. Description of the Related Art

Lithium ion secondary batteries are being widely used in portable electronic devices and power sources of hybrid automobiles or electric vehicles because of because of various advantages, including a high operation voltage, a high energy density per unit weight, and so forth.

The lithium ion secondary battery can be largely classified as cylinder type secondary battery, a prismatic type secondary battery, a pouch type secondary battery. Specifically, the cylindrical lithium ion secondary battery generally includes a cylindrical electrode assembly, a cylindrical can coupled to the electrode assembly, an electrolyte injected into the can to allow movement of lithium ions, and a cap assembly coupled to one side of the can to prevent leakage of the electrolyte and separation of the electrode assembly.

### SUMMARY

Embodiments are directed to a secondary battery including an electrode assembly, a can accommodating the electrode assembly, and a cap assembly sealing a top portion of the can and having a cap-up. The cap-up includes a base plate, a terminal in a protruding relationship with respect to an upper portion of the base plate, the terminal being at a center of the cap-up, a connection part connecting the base plate and the terminal, and a trench-shaped safety vent in the base plate. The safety vent may be shaped as a circle along the base plate.

The base plate may include a top surface and a bottom surface and further may include an inner circumferential surface and an outer circumferential surface connecting the top surface and the bottom surface. The inner circumferential surface may be a surface connected to the connection part. The outer circumferential surface may be an outermost surface of the cap-up.

The inner circumferential surface and the outer circumferential surface may be shaped as concentric circles. The safety vent may be formed between the inner circumferential surface and the outer circumferential surface.

The base plate may include top surface and a bottom surface. The safety vent may be on the bottom surface of the base plate.

The safety vent may include a first surface between the top surface and the bottom surface of the base plate and a pair of spaced-apart second surfaces connecting the first surface and the bottom surface of the base plate.

The safety vent further may include a pair of curved surfaces formed between the first surface and the pair of second surfaces.

A height from the bottom surface of the base plate to the first surface may be about 80% to about 90% of a height from the bottom surface to the top surface of the base plate.

The pair of second surfaces may form an angle of about 28° to about 30° with respect to each other.

The base plate may include top surface and a bottom surface. The safety vent may be on the top surface of the base plate. The safety vent may include a first surface between the top surface and the bottom surface of the base plate and a pair of spaced-apart second surfaces connecting the first surface and the top surface of the base plate. The safety vent further may include a pair of curved surfaces formed between the first surface and the pair of second surfaces, each of the curved surfaces having a curvature. A height from the top surface of the base plate to the first surface may be about 80% to about 90% of a height from the top surface to the bottom surface of the base plate. The pair of second surfaces may form an angle of about 28° to about 30° with respect to each other.

The terminal and the connection part may be separable from the cap-up if the safety vent is ruptured.

The secondary battery may be a cylindrical secondary battery.

Embodiments are also directed to a cap-up of a secondary battery including an electrode assembly, a can accommodating the electrode assembly, and a cap assembly sealing a top portion of the can. The cap-up includes a base plate, a terminal in a protruding relationship with respect to an upper portion of the base plate, the terminal being at a center of the cap-up, a connection part connecting the base plate and the terminal, and a trench-shaped safety vent in the base plate. The safety vent may be shaped as a circle formed along the base plate.

The base plate may include top surface and a bottom surface. The safety vent may be formed on the bottom surface of the base plate. The base plate may include top surface and a bottom surface. The safety vent may be formed on the top surface of the base plate.

### BRIEF DESCRIPTION OF THE DRAWINGS

Features will become apparent to those of ordinary skill in the art by describing in detail exemplary embodiments with reference to the attached drawings in which:

FIG. 1 A illustrates a perspective view of a secondary battery according to an embodiment, FIG. 1B illustrates a cross-sectional view of the secondary battery shown in FIG. 1A, and FIG. 1C illustrates an exploded perspective view of the secondary battery shown in FIG. 1A;

FIG. 2A illustrates a cross-sectional view of a cap-up of the secondary battery shown in FIG. 1A, FIG. 2B illustrates a bottom view of the cap-up shown in FIG. 2A, and FIG. 2C illustrates an enlarged cross-sectional view of a safety vent shown in FIG. 2A; and

FIG. 3A illustrates a cross-sectional view of a cap-up according to another embodiment, FIG. 3B illustrates a plan view of the cap-up shown in FIG. 3A, and FIG. 3C illustrates an enlarged cross-sectional view of a safety vent shown in FIG. 3A.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions may be exaggerated for clarity of illustration. Like reference numerals refer to like elements throughout.

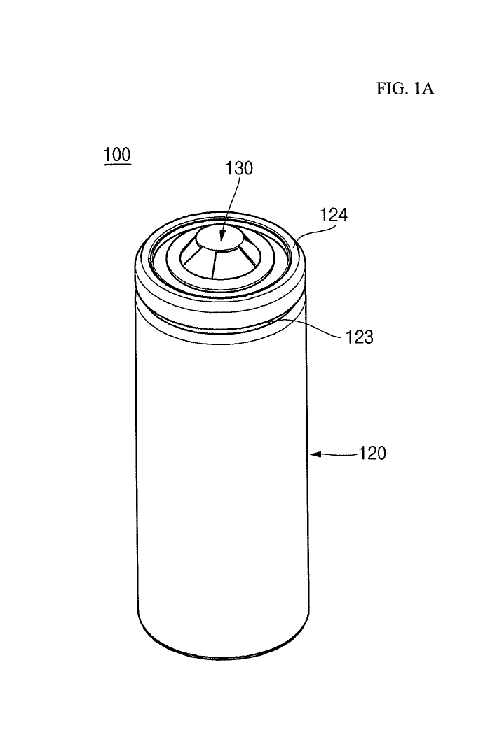

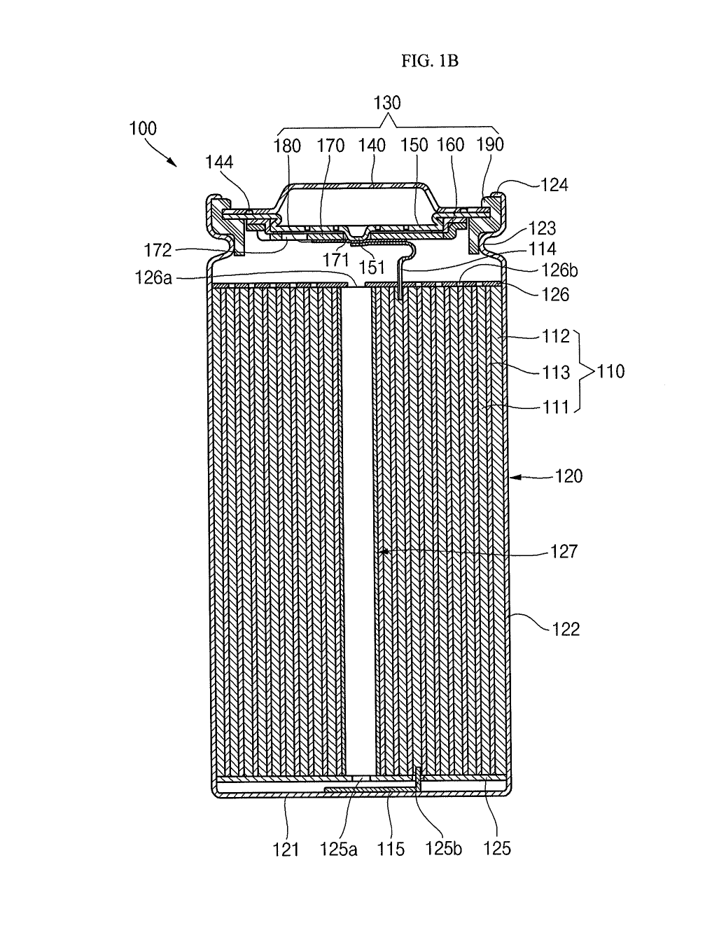

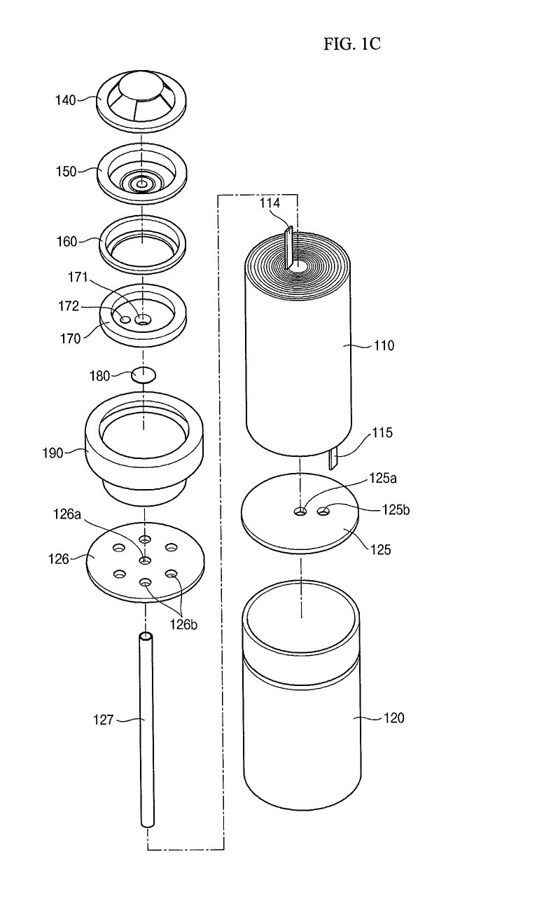

FIG. 1A illustrates a perspective view of a secondary battery according to an embodiment, FIG. 1B illustrates a cross-sectional view of the secondary battery shown in FIG. 1A, and FIG. 1C illustrates an exploded perspective view of the secondary battery shown in FIG. 1A.

Referring to FIGS. 1A and 1C, the secondary battery 100 includes an electrode assembly 110, a can 120 and a cap assembly 130.

The electrode assembly 110 includes a positive electrode plate 111 coated on a positive electrode current collector with a positive electrode active material (e.g., a transition metal oxide, such as LiCoO₂, LiNiO₂, LiMn₂O₄, etc.), a negative electrode plate 112 coated on a negative electrode current collector with a negative electrode active material (e.g., graphite, carbon, etc.), and a separator 113 positioned between the positive electrode plate 111 and the negative electrode plate 112 to electrically insulate the positive electrode plate 111 and the negative electrode plate 112. The separator 113 may be made of a porous polymer material to allow movement of lithium ions while preventing an electric short between the positive electrode plate 111 and the negative electrode plate 112.

The positive electrode plate 111, the negative electrode plate 112 and the separator 113 may be wound up in a substantially cylindrical shape. The positive electrode plate 111 may be made of an aluminum (Al) foil, the negative electrode plate 112 may be made of a copper (Cu) foil, and the separator 113 may be made of polyethylene (PE) or polypropylene (PP), as examples.

In addition, a positive electrode tab 114 projecting upwardly with a predetermined length may be welded to the positive electrode plate 111. A negative electrode tab 115 projecting downwardly and extending with a predetermined length may be welded to the negative electrode plate 112. In other implementations, the positive electrode tab 114 may project downwardly, and the negative electrode tab 115 may project upwardly. The positive electrode tab 114 may be made of aluminum (Al) and the negative electrode tab 115 may be made of nickel (Ni), as examples.

The can 120 may include a circular bottom portion 121 having a predetermined diameter and a side portion 122 upwardly extending from the bottom portion 121 a predetermined length, to provide a space to accommodate the electrode assembly 110. The can 120 may be formed to have a cylinder shape to accommodate the cylindrically wound electrode assembly 110. In the course of fabricating the secondary battery, a top portion of the can 120 is opened. Therefore, the electrode assembly 110 and a center pin 127 may be inserted into the can 120 with an electrolyte. The can 120 may be made of steel, stainless steel, aluminum, an aluminum alloy, or equivalents thereof, as examples. In addition, the can 120 may include an inwardly recessed beading part 123 formed at a lower portion of the cap assembly 130 to prevent the cap assembly 130 from deviating to the outside, and an inwardly bent crimping part 124 formed at an upper portion of the cap assembly 130.

The negative electrode tab 115 of the electrode assembly 110 may be welded to the bottom portion 121 of the can 120 such that, the can 120 may function as a negative electrode. In other implementations, the positive electrode tab 114 may be welded to the bottom portion 121 of the can 120 such that the can 120 may function as a positive electrode.

A first insulating plate 125 coupled to the can 120 and including a first hole 125a formed at its center and a second hole 125b formed at its exterior portion may be interposed between the electrode assembly 110 and the bottom portion 121. The first insulating plate 125 may prevent the electrode assembly 110 from electrically contacting the bottom portion 121 of the can 120. In particular, the first insulating plate 125 may prevent the positive electrode plate 111 of the electrode assembly 110 from electrically contacting the bottom portion 121. When a large amount of gas is generated due to abnormality of the secondary battery, the first hole 125a may allow the gas to rapidly move upwardly through the center pin 127. The second hole 125b may allow the negative electrode tab 115 to pass through the same to be welded to the bottom portion 121.

In addition, a second insulating plate 126 coupled to the can 120 and including a first hole 126a formed at its center and a plurality of second holes 126b formed at its exterior portion may be interposed between the electrode assembly 110 and the cap assembly 130. The second insulating plate 126 may prevent the electrode assembly 110 from electrically contacting the cap assembly 130. In particular, the second insulating plate 126 may prevent the negative electrode plate 112 of the electrode assembly 110 from electrically contacting the cap assembly 130. When a large amount of gas is generated due to abnormality of the secondary battery, the first hole 126a may allow the gas to rapidly move to the cap assembly 130. The second holes 126b may allow the positive electrode tab 114 to pass through the same to be welded to the cap assembly 130. In an electrolyte injection process, the second holes 126b may allow the electrolyte to rapidly flow into the electrode assembly 110.

In addition, diameters of the first holes 125a and 126a of the first and second insulating plates 125 and 126 may be smaller than a diameter of the center pin 127. Accordingly, it may be possible to prevent the center pin 127 from electrically contacting the bottom portion 121 of the can 120 or the cap assembly 130 in response to an external shock.

The center pin 127 may be shaped as a hollow cylindrical pipe and may be coupled to a substantially central portion of the electrode assembly 110. The center pin 127 may be made of steel, stainless steel, aluminum, an aluminum alloy, or polybutylene terephthalate, as examples. The center pin 127 may prevent the electrode assembly 110 from being deformed during charging or discharging of the secondary battery, and may serve as a path of gas movement.

The cap assembly 130 may be coupled to a top portion of the can 120 and may seal the can 120. The cap assembly 130 may include a cap-up 140, a safety plate 150 formed under the cap-up 140, an insulating plate 160 installed under the safety plate 150, a cap-down 170 installed under the safety plate 150 and the insulating plate 160, a sub-plate 180 fixed on a bottom surface of the cap-down 170 and electrically connected to the positive electrode tab 114, and an insulation gasket 190 insulating the cap-up 140, the safety plate 150, the insulating plate 160, the cap-down 170 and a side portion 122 of the can 120.

The cap-up 140 is electrically connected to the electrode assembly 110 and includes a convexly formed upper portion to be electrically connected to an external device (not shown). A safety vent 144 shaped as a trench having a predetermined depth is formed in the cap-up 140. When an internal pressure of the can 120 excessively increases due to abnormality of the secondary battery, the safety vent 144 may be ruptured and the internal gas may be discharged to the outside. The rupture pressure of the cap-up 140 may be controlled according to the depth, angle and curvature of the safety vent 144. The cap-up 140 including the safety vent 144 will be described below in more detail.

The safety plate 150 may be shaped as a circular plate corresponding to the cap-up 140 and may include a protrusion part 151 downwardly protruding at its center. The safety plate 150 may be electrically connected to the sub-plate 180 fixed to the bottom surface of the cap-down 170 through the protrusion part 151 passing through a first through-hole 171 of the cap-down 170. When the internal pressure of the can 120 abnormally rises, the safety plate 150 may make a close contact with a region of the cap-up 140 other than an upwardly convex region and may discharge the internal gas while blocking the current. When the internal pressure of the can 120 is greater than or equal to the operating pressure of the safety plate 150, the protrusion part 151 of the safety plate 150 may be upwardly moved by the gas discharged through the second through-hole 172 of the cap-down 170 to then be electrically separated from the sub-plate 180. In addition, when the internal pressure of the can 120 is greater than or equal to the rupture pressure, which is higher than the operating pressure of the safety plate 150, the safety plate 150 may be ruptured.

The insulating plate 160 may be interposed between the safety plate 150 and the cap-down 170 and may insulate the safety plate 150 and the cap-down 170 from each other.

The cap-down 170 may be shaped as a circular plate. A first through-hole 171 may be formed at a center of the cap-down 170 to allow the protrusion part 151 of the safety plate 150 to pass therethrough. In addition, a second through-hole 172 through which the internal gas of the can 120 is discharged when the internal pressure of the can 120 abnormally rises may be formed at the exterior side of the first through-hole 171.

The sub-plate 180 may be positioned under the cap-down 170 and the positive electrode tab 114 may be welded to the sub-plate 180. In addition, the sub-plate 180 may be positioned between the protrusion part 151 of the safety plate 150 and the positive electrode tab 114 to electrically connect the positive electrode tab 114 and the safety plate 150. When the internal pressure of the can 120 excessively rises, the protrusion part 151 of the safety plate 150 may be upwardly moved, thereby allowing the sub-plate 180 to then be electrically separated from the safety plate 150.

The insulation gasket 190 may be installed at a top portion of the can 120. The insulation gasket 190 may be compressed between circumferential surfaces of the cap-up 140 and the safety plate 150 and the beading part 123 and the crimping part 124. The insulation gasket 190 may prevent the cap assembly 130 from being separated from the can 120 while insulating the can 120 and the cap assembly 130 from each other.

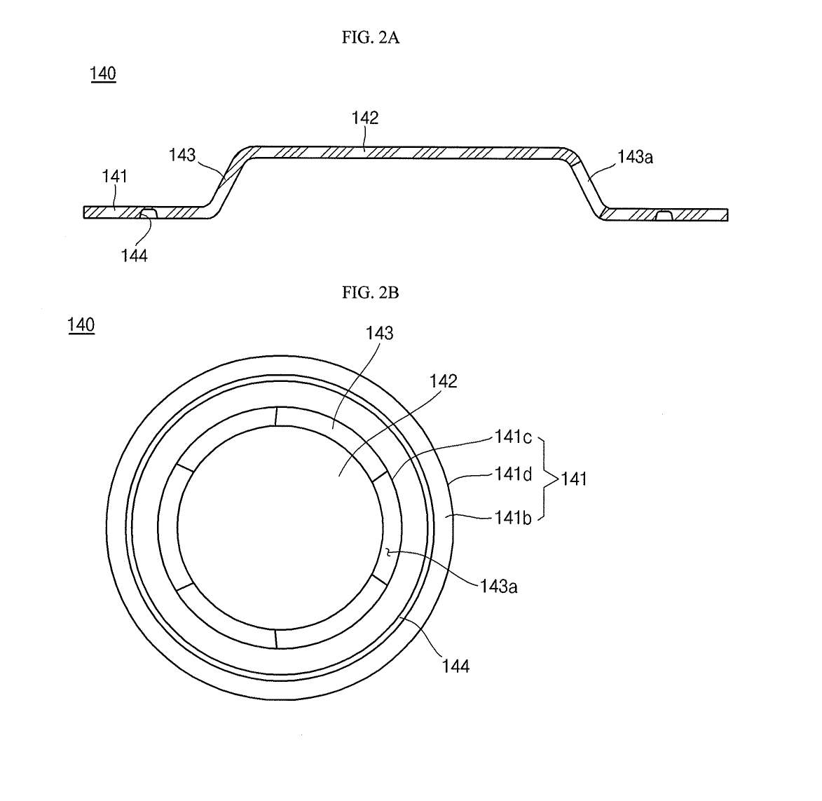

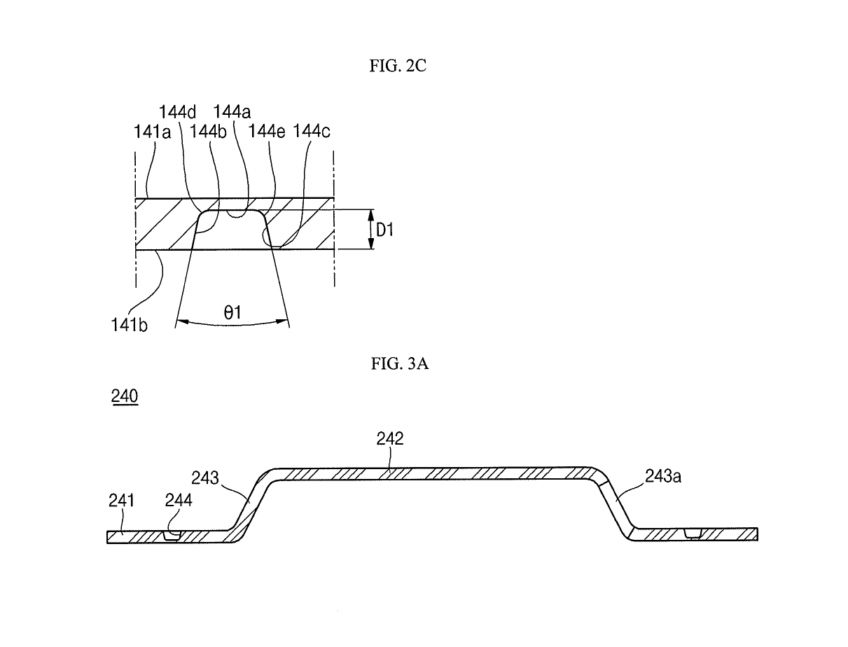

FIG. 2A illustrates a cross-sectional view of a cap-up of the secondary battery shown in FIG. 1A, FIG. 2B illustrates a bottom view of the cap-up shown in FIG. 2A, and FIG. 2C illustrates an enlarged cross-sectional view of a safety vent shown in FIG. 2A.

Referring to FIGS. 2A to 2C, the cap-up 140 includes a planarly formed base plate 141, a terminal 142 protruding from the base plate 141 and planarly formed, a connection part 143 connecting the base plate 141 and the terminal 142, the connection part 143 including a through-hole 143a, and a safety vent 144 formed under the base plate 141. The cap-up 140 may be made of steel or stainless steel, and a nickel plating may be formed thereon. The nickel plating may be formed on the cap-up 140 to prevent corrosion of the cap-up 140 and to allow an electrode tab (not shown) of an external device to be easily welded to the cap-up 140.

The base plate 141 is formed at an outer peripheral edge of the cap-up 140 and includes a substantially planar top surface 141a and a bottom surface 141b. In addition, the base plate 141 may include an inner circumferential surface 141c and an outer circumferential surface 141d connecting the top surface 141a and the bottom surface 141b. The inner circumferential surface 141c may be a surface connected to the connection part 143, and the outer circumferential surface 141d may be an outermost surface of the cap-up 140. The inner circumferential surface 141c and the outer circumferential surface 141b may be shaped as concentric circles. The base plate 141 may be shaped as a doughnut along the inner circumferential surface 141c and the outer circumferential surface 141d. The base plate 141 may be electrically connected to the safety plate 150. In addition, the insulation gasket 190 may be formed at an outer peripheral edge of the base plate 141.

The terminal 142 protrudes from the base plate 141 and may be planarly formed. The terminal 142 is positioned at the center of the cap-up 140 and is formed stepwise with respect to the base plate 141. The terminal 142 may be electrically connected to the positive electrode tab 114 of the electrode assembly 110, functioning as a positive electrode. The terminal 142 may function as a terminal directly connected to an electrode tab of an external device.

The connection part 143 connects the base plate 141 and the terminal 142. The connection part 143 may be formed such that its upper perimeter connected to the terminal 142 is smaller than its lower perimeter connected to the base plate 141. Therefore, the connection part 143 may be slantingly formed. In addition, the connection part 143 may have a through-hole 143a through which gases generated from the can 120 are discharged. The through-hole 143a may include a plurality of through-holes, as an example.

The safety vent 144 may be formed on the bottom surface 141b of the base plate 141. The safety vent 144 may be shaped as a trench having a predetermined depth. The safety vent 144 may be formed to have a substantially circular ring shape along the bottom surface 141b of the base plate 141. The ring-shaped safety vent 144 may be formed at the center of the inner and outer circumferential surfaces 141c and 141d of the base plate 141. In other implementations, the safety vent 144 could be formed in the terminal 142 or the connection part 143 of the cap-up 140. However, if the terminal 142 and the connection part 143 are formed by pressing a planar main plate of the cap-up 140 using a jig, if the safety vent 114 is pre-formed at a potential region of the connection part 143, there may be a possibility that the safety vent 144 could be ruptured in the course of pressing the cap-up 140 using the jig. If the safety vent 114 is formed at the connection part 143 by pressing the main plate using a jig after the terminal 142 and the connection part 143 are formed, it may be difficult to form the safety vent 114 in the connection part 143, since the connection part 143 is not shaped as a planar plate. In addition, it may not be desirable to form the safety vent 114 at the terminal 142, since the electrode tab of an external device may be welded to the terminal 142. Therefore, the safety vent 144 is most preferably formed at the base plate 141 of the cap-up 140.

When the internal pressure of the can 120 abnormally rises, the safety vent 144 is ruptured to discharge the internal gases of the can 120. If the safety vent 144 is ruptured, the terminal 142 and the connection part 143 of the cap-up 140 may break away to the outside. If the safety vent 144 is ruptured, the terminal 142 and the connection part 143 may be detached from the cap-up 140. In addition, a portion of the base plate 141 formed inside the safety vent 144 may be separated from the cap-up 140. Therefore, the safety vent 144 may rapidly discharge the internal gas and may rapidly lower the internal temperature.

As described above, the secondary battery generally includes a safety plate that ruptures while blocking the flow of current when the internal pressure of the can abnormally rises, and a cap-up having a through-hole through which the internal gas is discharged. If the internal pressure of the can abnormally rises, the internal temperature of the can may rapidly rise so as to melt the safety plate. As a result, when the safety plate is ruptured, fragments of the ruptured safety plate may be melted to clog up the through-hole of the cap-up, making it difficult to discharge the internal gas. Accordingly, the secondary battery 100 may include the safety vent 144 formed in the base plate 141 of the cap-up 140. The safety vent 144 may be ruptured current when the internal pressure of the can 120 abnormally rises, so that the terminal 142 and the connection part 143 may break away to the outside of the can 120, thereby rapidly discharging the internal gas. Therefore, in the secondary battery 100, there risk of the safety plate 150 clogging up the through-hole 143a may be minimized.

As shown in FIG. 2C, the base plate 141 includes the substantially planar top surface 141a and the bottom surface 141b. The safety vent 144, shaped as a trench having a predetermined depth from the bottom surface 141b, is formed in the cap-up 140. The safety vent 144 may include a first surface 144a formed between the top surface 141a and the bottom surface 141b of the base plate 141, and a pair of spaced-apart second surfaces 144b and 144c formed at both sides of the first surface 144a and connected to the bottom surface 141b of the base plate 141. The first surface 144a of the safety vent 144 may be formed to be substantially parallel with the top surface 141a and the bottom surface 141b of the base plate 141. In addition, a pair of curved surfaces 144d and 144e having a predetermined curvature may be formed between the first surface 144a and the pair of second surfaces 144b and 144c of the safety vent 144.

A depth D1 of the safety vent 144 may be determined in consideration of a height from the bottom surface 141 of the base plate 141 to the first surface 144a. The depth D1 of the safety vent 144 may be approximately 80% to approximately 90% of a height from the top surface 141a to the bottom surface 141b of the base plate 141. If the depth D1 of the safety vent 144 is greater than approximately 90% of the height from the top surface 141a to the bottom surface 141b of the base plate 141, the safety vent 144 may be ruptured at a relatively low internal pressure of the battery. In addition, if the depth D1 of the safety vent 144 is greater than approximately 90% of the height from the top surface 141a to the bottom surface 141b of the base plate 141, the safety vent 144 may be highly prone to cracks even in response to a small external shock. If the depth D1 of the safety vent 144 is less than approximately 80% of the height from the top surface 141a to the bottom surface 141b of the base plate 141, the safety vent 144 may not be ruptured at a relatively high internal pressure of the battery.

As described above, the larger the depth D1 of the safety vent 144, the lower the internal pressure at which the safety vent 144 is ruptured, and the smaller the depth D1 of the safety vent 144, the higher the internal pressure at which the safety vent 144 is ruptured. Accordingly, the rupture pressure of the cap-up 140 may be controlled by adjusting the depth D1 of the safety vent 144 (the height from the bottom surface 141b of the base plate 141 to the first surface 144a).

In addition, an angle θ1 formed between the pair of second surfaces 144b and 144c (that is, an angle θ1 that would be formed if the second surfaces 144b and 144c were extended to a meeting point) may be in a range of approximately 28° to approximately 30°. If the angle θ1 formed between the pair of second surfaces 144b and 144c is greater than approximately 30°, the safety vent 144 may be ruptured at a relatively low internal pressure of the battery. If the angle θ1 formed between the pair of second surfaces 144b and 144c is greater than approximately 30°, the safety vent 144 may be highly prone to cracks even at a small external shock. If the angle θ1 formed between the pair of second surfaces 144b and 144c is smaller than approximately 28°, the safety vent 144 may not be ruptured at a relatively high internal pressure of the battery.

As described above, the larger the angle θ1 formed between the pair of second surfaces 144b and 144c, the lower the internal pressure at which the safety vent 144 is ruptured, and the smaller the angle θ1 formed between the pair of second surfaces 144b and 144c, the higher the internal pressure at which the safety vent 144 is ruptured. The rupture pressure of the cap-up 140 may be controlled by adjusting the angle θ1 formed between the pair of second surfaces 144b and 144c.

Each of the pair of curved surfaces 144d and 144e may have a predetermined curvature. The larger the curvature of each of the pair of curved surfaces 144d and 144e, the lower the internal pressure at which the safety vent 144 is ruptured, and the smaller the curvature of each of the pair of curved surfaces 144d and 144, the higher the internal pressure at which the safety vent 144 is ruptured. The rupture pressure of the cap-up 140 may be controlled according to the curvatures of the pair of curved surfaces 144d and 144e.

As described above, in the secondary battery 100 according to the embodiment, the safety vent 144 is formed in the cap-up 140 and includes the first surface 144a, the pair of second surfaces 144b and 144c and the pair of curved surfaces 144d and 144e. The rupture pressure of the cap-up 140 can be controlled by adjusting the depth D1 of the safety vent 144, the angle θ1 formed between the pair of second surfaces 144b and 144c, and the curvatures of the pair of curved surfaces 144d and 144e.

Next, a cap-up of a secondary battery according to another embodiment will be described.

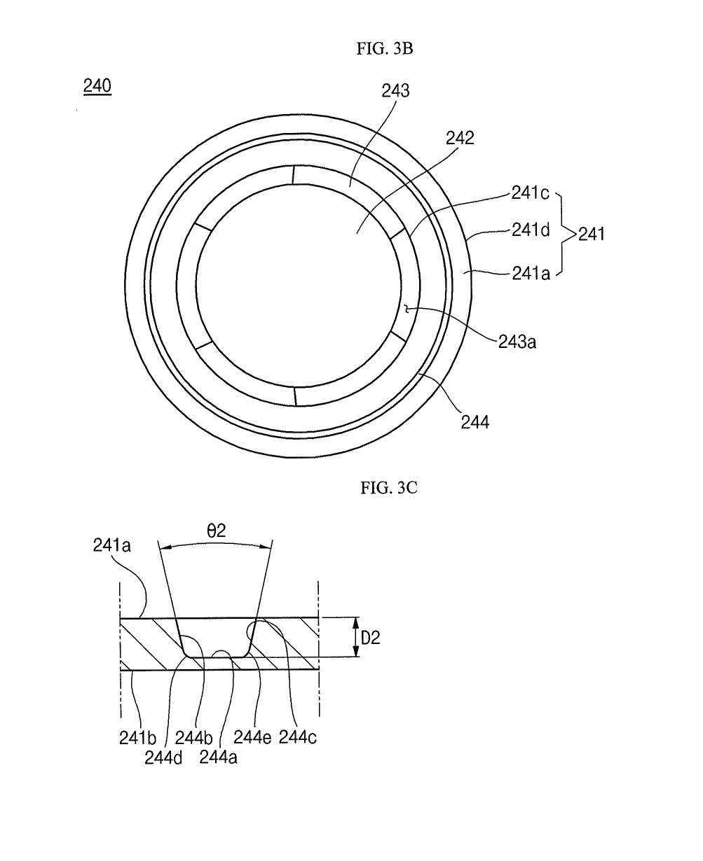

FIG. 3A illustrates a cross-sectional view of a cap-up according to another embodiment, FIG. 3B illustrates a plan view of the cap-up shown in FIG. 3A, and FIG. 3C illustrates an enlarged cross-sectional view of a safety vent shown in FIG. 3A.

Referring to FIGS. 3A to 3C, the cap-up 240 includes a planarly formed base plate 241, a terminal 242 protruding from the base plate 241 and planarly formed, a connection part 243 connecting the base plate 241 and the terminal 242, the connection part 243 having a through-hole 243a, and a safety vent 244 formed on the base plate 241. The cap-up 240 according to this embodiment is substantially the same as the cap-up 140 shown in FIGS. 2A to 2C, except for the location of the safety vent 244. Therefore, the following description will focus on the differences between the cap-up 140 and the cap-up 240.

The base plate 241 is formed at an outer peripheral edge of the cap-up 240 and includes a substantially planar top surface 241a and a bottom surface 241b. In addition, the base plate 241 may include an inner circumferential surface 241c and an outer circumferential surface 241d connecting the top surface 241a and the bottom surface 241b. The inner circumferential surface 241c may be a surface connected to the connection part 243, and the outer circumferential surface 241d may be an outermost surface of the cap-up 240. The inner circumferential surface 241c and the outer circumferential surface 241b may be shaped as concentric circles. The base plate 241 may have a shape of a doughnut along the inner circumferential surface 241c and the outer circumferential surface 241d.

The safety vent 244 may be formed on a top surface 241a of the base plate 241. The safety vent 244 may be shaped as a trench having a predetermined depth. The safety vent 244 may be formed to have a substantially circular ring shape along the top surface 241a of the base plate 241. The ring-shaped safety vent 244 may be formed at the center of the base plate 241.

In addition, the safety vent 244 may be shaped as a trench having a predetermined depth from the top surface 241a. The safety vent 244 may include a first surface 244a formed between the top surface 241a and the bottom surface 241b of the base plate 241, and a pair of spaced-apart second surfaces 244b and 244c formed at both sides of the first surface 244a and connected to the top surface 241a of the base plate 241. The first surface 244a of the safety vent 244 may be formed to be substantially parallel with the top surface 241a and the bottom surface 241b of the base plate 241. In addition, a pair of curved surfaces 244d and 244e having a predetermined curvature may be formed between the first surface 244a and the pair of second surfaces 244b and 244c of the safety vent 244.

The functional effects of a depth D2 of the safety vent 244, an angle θ2 formed by the pair of second surfaces 244b and 244c and curvatures of a pair of curved surfaces 244d and 244e may be the same as those of the safety vent 144, and detailed descriptions thereof will not be repeated.

By way of summation and review, a secondary battery may include a cap-up having a through-hole for releasing the gases generated in a can to the outside of the can when the internal temperature and pressure of the battery rise due to an abnormal operation of battery, such as battery short or an overcharge. In addition, a safety plate ruptured while blocking the flow of current in an event of an internal short is formed under the cap-up. In an abnormal operation of the battery, fragments of the ruptured safety plate may be melted and may clog up the through-hole, thereby blocking a gas discharge path. Accordingly, the internal temperature of the secondary battery may further rise, and the gases may not be properly released.

In contrast, embodiments may provide a secondary battery that may rapidly reduce the internal temperature of a can while easily releasing the gas generated from the can. The secondary battery includes a trench-shaped safety vent formed in a cap-up. Accordingly, the internal temperature of a can may be rapidly reduced and the gas generated from the can may be easily reduced. In addition, the rupture pressure of the cap-up may be controlled. Hence, the embodiments are directed to a secondary battery that represents an advance in the art.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A secondary battery, comprising:
an electrode assembly;
a can accommodating the electrode assembly; and
a cap assembly sealing a top portion of the can and having a cap-up,
wherein the cap-up includes:
a base plate,
a terminal in a protruding relationship with respect to an upper portion of the base plate, the terminal being at a center of the cap-up,
a connection part connecting the base plate and the terminal, and
a trench-shaped safety vent in the base plate.

2. The secondary battery as claimed in claim 1, wherein the safety vent has a shape of a circle along the base plate.

3. The secondary battery as claimed in claim 1, wherein:
the base plate includes a top surface and a bottom surface and further includes an inner circumferential surface and an outer circumferential surface connecting the top surface and the bottom surface,
the inner circumferential surface is a surface connected to the connection part, and
the outer circumferential surface is an outermost surface of the cap-up.

4. The secondary battery as claimed in claim 3, wherein:
the inner circumferential surface and the outer circumferential surface are in shapes of concentric circles, and
the safety vent is formed between the inner circumferential surface and the outer circumferential surface.

5. The secondary battery as claimed in claim 1, wherein:
the base plate includes top surface and a bottom surface, and
the safety vent is on the bottom surface of the base plate.

6. The secondary battery as claimed in claim 5, wherein the safety vent includes a first surface between the top surface and the bottom surface of the base plate and a pair of spaced-apart second surfaces connecting the first surface and the bottom surface of the base plate.

7. The secondary battery as claimed in claim 6, wherein the safety vent further includes a pair of curved surfaces formed between the first surface and the pair of second surfaces.

8. The secondary battery as claimed in claim 6, wherein a height from the bottom surface of the base plate to the first surface is about 80% to about 90% of a height from the bottom surface to the top surface of the base plate.

9. The secondary battery as claimed in claim 6, wherein the pair of second surfaces form an angle of about 28° to about 30° with respect to each other.

10. The secondary battery as claimed in claim 1, wherein:
the base plate includes top surface and a bottom surface, and
the safety vent is on the top surface of the base plate.

11. The secondary battery as claimed in claim 10, wherein the safety vent includes a first surface between the top surface and the bottom surface of the base plate and a pair of spaced-apart second surfaces connecting the first surface and the top surface of the base plate.

12. The secondary battery as claimed in claim 11, wherein the safety vent further includes a pair of curved surfaces formed between the first surface and the pair of second surfaces.

13. The secondary battery as claimed in claim 11, wherein a height from the top surface of the base plate to the first surface is about 80% to about 90% of a height from the top surface to the bottom surface of the base plate.

14. The secondary battery as claimed in claim 11, wherein the pair of second surfaces form an angle of about 28° to about 30° with respect to each other.

15. The secondary battery as claimed in claim 1, wherein the terminal and the connection part are separable from the cap-up if the safety vent is ruptured.

16. The secondary battery as claimed in claim 1, wherein the secondary battery is a cylindrical secondary battery.

17. A cap-up of a secondary battery including an electrode assembly, a can accommodating the electrode assembly, and a cap assembly sealing a top portion of the can, the cap-up comprising:
a base plate;
a terminal in a protruding relationship with respect to an upper portion of the base plate, the terminal being at a center of the cap-up;
a connection part connecting the base plate and the terminal; and
a trench-shaped safety vent in the base plate.

18. The cap-up as claimed in claim 17, wherein the safety vent has a shape of a circle formed along the base plate.

19. The cap-up as claimed in claim 17, wherein:
the base plate includes top surface and a bottom surface, and
the safety vent is formed on the bottom surface of the base plate.

20. The cap-up as claimed in claim 17, wherein:
the base plate includes top surface and a bottom surface, and
the safety vent is formed on the top surface of the base plate.
